(19) United States
(12) Patent Application Publication
(10) Pub. No.: US 2007/0224995 A1
(43) Pub. Date: Sep. 27, 2007

(54) Apparatus, methods and computer program products providing signaling of time staggered measurement reports and scheduling in response thereto

(75) Inventors: Frank Frederiksen, Klarup (DK); Troels Kolding, Klarup (DK)

Correspondence Address: HARRINGTON & SMITH, PC, 4 RESEARCH DRIVE, SHELTON, CT, 06484-6212, US

(73) Assignee: Nokia Corporation

(21) Appl. No.: 11/724,860

(22) Filed: Mar. 16, 2007

Related U.S. Application Data
(60) Provisional application No. 60/783,215, filed on Mar. 16, 2006.

(51) Int. Cl. H04Q 7/20

(52) U.S. Cl. 455/437

(57) ABSTRACT

A method includes determining a value representative of an overall quality of a set of channels and transmitting during a reporting interval an indication of the determined value. The method also includes determining at least one additional value representative of a quality of a subset of the set of channels, and transmitting in at least one subsequent reporting interval an indication of the at least one additional value. Another method includes receiving during a reporting interval an indication of a value representative of an overall quality of a set of channels and receiving during at least one subsequent reporting interval an indication of at least one additional value representative of a quality of a subset of the set of channels. The method further includes, using the values, scheduling resources associated with the channels in the set, and transmitting an indication of the scheduled resources.

### CROSS-REFERENCE TO RELATED APPLICATIONS

The present application claims the benefit under 35 U.S.C. §119(e) of U.S. Provisional Patent Application No. 60/783,215, filed on Mar. 16, 2006, the disclosure of which is hereby incorporated by reference in its entirety.

### TECHNICAL FIELD

The exemplary and non-limiting embodiments of this invention relate generally to wireless communications systems and, more specifically, relate to measurement reporting techniques between a user equipment and a network.

### BACKGROUND

The following abbreviations are herewith defined:

| | |
|---|---|
| 3GPP | third generation partnership project |
| CQI | channel quality indicator |
| LA | link adaptation |
| LTE | long term evolution |
| OFDM | orthogonal frequency division multiplex |
| Node B | base station |
| PRB | physical resource block |
| PS | packet scheduler |
| RNC | radio network controller |
| SINR | signal to interference noise ratio |
| UE | user equipment |
| UMTS | universal mobile telecommunications system |
| UTRAN | UMTS terrestrial radio access network |

A working assumption in 3GPP has been that the access technique for LTE will be OFDM, which will provide an opportunity to perform link adaptation and user multiplexing in the frequency domain. In order to accomplish this adaptation in the frequency domain, it is important that the packet scheduler and link adaptation units in the Node B have knowledge of the instantaneous channel quality. This is obtained through the signaling of channel quality indication (CQI) reports from the different UEs. Ideally, these CQI reports will be available with infinite resolution and ‘zero’ delay. However, this would require the uplink signaling bandwidth to be infinite. As such, to transfer these CQI reports, the measured values are quantized to an agreed upon set of levels, and transmitted with a certain finite delay.

It can be shown that a total number of four to five bits are needed per CQI report in order to obtain near-optimum performance of the link adaptation/packet scheduling in the frequency domain when also considering signaling delays and measurement errors. However, as these measurement reports need be updated frequently, they would require a large amount of uplink signaling bandwidth (especially since the current working assumption in 3GPP is that 48 resource blocks should be used for scheduling). Furthermore, since the CQI reports are potentially sent for every sub-frame (e.g., 0.5 ms, millisecond), the required uplink bandwidth will be in the order of 48 resource blocks*4 bits/resource block/sub-frame*2000 sub-frames/second=384 kbps (kilobits per second) per UE for the CQI reporting function alone. A problem is thus created, in that a brute force CQI signaling approach would require an excessive and unrealistic amount of uplink signaling bandwidth.

### BRIEF SUMMARY

In an exemplary embodiment, a method is disclosed that includes determining a value representative of an overall quality of a set of channels and transmitting during a reporting interval an indication of the determined value. The method also includes determining at least one additional value representative of a quality of a subset of the set of channels, and transmitting in at least one subsequent reporting interval an indication of the at least one additional value.

In another exemplary embodiment, an apparatus includes a quality module configured to determine a value representative of an overall quality of a set of channels and configured to determine at least one additional value representative of a quality of a subset of the set of channels. The apparatus also includes a transceiver configured to transmit during a reporting interval an indication of the determined value and configured to transmit in at least one subsequent reporting interval an indication of the at least one additional value.

In a further exemplary embodiment, a computer program product is disclosed that tangibly embodies a program of machine-readable instructions executable by at least one data processor to perform operations. The operations include determining a value representative of an overall quality of a set of channels, transmitting during a reporting interval an indication of the determined value, determining at least one additional value representative of a quality of a subset of the set of channels, and transmitting in at least one subsequent reporting interval an indication of the at least one additional value.

In a further exemplary embodiment, a method is disclosed that includes receiving during a reporting interval an indication of a value representative of an overall quality of a set of channels and receiving during at least one subsequent reporting interval an indication of at least one additional value representative of a quality of a subset of the set of channels. The method further includes, using the values, scheduling resources associated with the channels in the set, and transmitting an indication of the scheduled resources.

In an additional exemplary embodiment, an apparatus includes a transceiver configured to receive during a reporting interval an indication of a value representative of an overall quality of a set of channels and configured to receive during at least one subsequent reporting interval an indication of at least one additional value representative of a quality of a subset of the set of channels. The apparatus also includes at least one scheduling module configured, using the values, to schedule resources associated with the channels in the set. The transceiver is further configured to transmit an indication of the scheduled resources.

In another exemplary embodiment, a computer program product is disclosed that tangibly embodies a program of machine-readable instructions executable by at least one data processor to perform operations. The operations include receiving during a reporting interval an indication of a value representative of an overall quality of a set of channels, and receiving during at least one subsequent reporting interval an indication of at least one additional value representative of a quality of a subset of the set of channels. The operations also include, using the values, scheduling resources associated with the channels in the set, and transmitting an indication of the scheduled resources.

### BRIEF DESCRIPTION OF THE DRAWINGS

The foregoing and other aspects of embodiments of this invention are made more evident in the following Detailed Description of Exemplary Embodiments, when read in conjunction with the attached Drawing Figures, wherein:

FIG. 1 shows a simplified block diagram of various electronic devices that are suitable for use in practicing the exemplary embodiments of this invention.

FIG. 2 depicts a set of measurement reports as well as a ‘tree’ structure representing potential incremental information to transmit.

FIG. 3 is a flowchart of an exemplary method performed by a UE for providing hierarchical-based signaling of measurement reports.

FIG. 4 is a flowchart of another exemplary method performed by a UE for providing hierarchical-based signaling of measurement reports.

FIG. 5 is a flowchart of an exemplary method performed by a base station for performing scheduling based on hierarchical-based signaling of measurement reports.

### DETAILED DESCRIPTION OF EXEMPLARY EMBODIMENTS

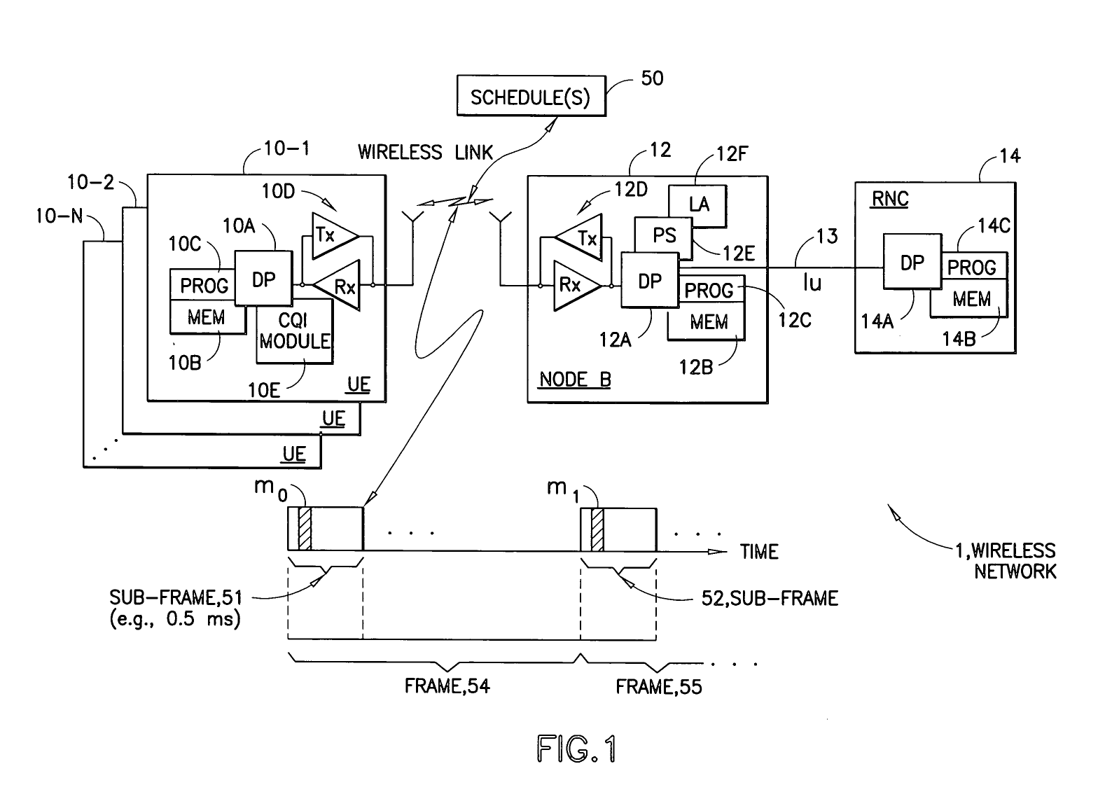

Reference is made first to FIG. 1 for illustrating a simplified block diagram of various electronic devices that are suitable for use in practicing the exemplary embodiments of this invention. In FIG. 1, a wireless network 1 is adapted for communication with N UEs 10-1 through 10-N via a Node B (e.g., a base station) 12. The network 1 may include a serving RNC 14, or other radio controller function. The UE 10-1 includes a data processor (DP) 10A, a memory (MEM) 10B that stores a program (PROG) 10C, and a suitable radio frequency (RF) transceiver 10D (having a receiver, Rx, and a transmitter, Tx) for bidirectional wireless communications with the Node B 12, which also includes a DP 12A, a MEM 12B that stores a PROG 12C, and a suitable RF transceiver 12D (having a receiver, Rx, and a transmitter, Tx). The UEs 10-2 through 10-N are expected to be similar to the UE 10-1. The Node B 12 may be coupled via a data path 13 (e.g., Iu) to a serving or other RNC 14. The RNC 14 includes a DP 14A and a MEM 14B that stores a PROG 14C. At least one of the PROGs 10C and 12C is assumed to include program instructions that, when executed by the associated DP, enable the electronic device to operate in accordance with the exemplary embodiments of this invention, as will be discussed below in greater detail.

Related more specifically to the exemplary embodiments of this invention, the UE 10-1 is shown to include a CQI module 10E that is assumed to be responsible for generating and transmitting CQI reports in accordance with the exemplary embodiments of this invention, and the Node B 12 is assumed to include a Packet Scheduler (PS) 12E and Link Adaptation (LA) 12F modules that respond to the CQI reports sent by the UE 10-1. One typical response is one or more schedules 50, communicated by the Node B 12 to the UE on a downlink. The one or more schedules 50 are determined by one or both of the PS 12E or the LA 12F, and the one or more schedules 50 indicate a schedule of resources to the UE 10 and other UEs 10-2 through 10-N.

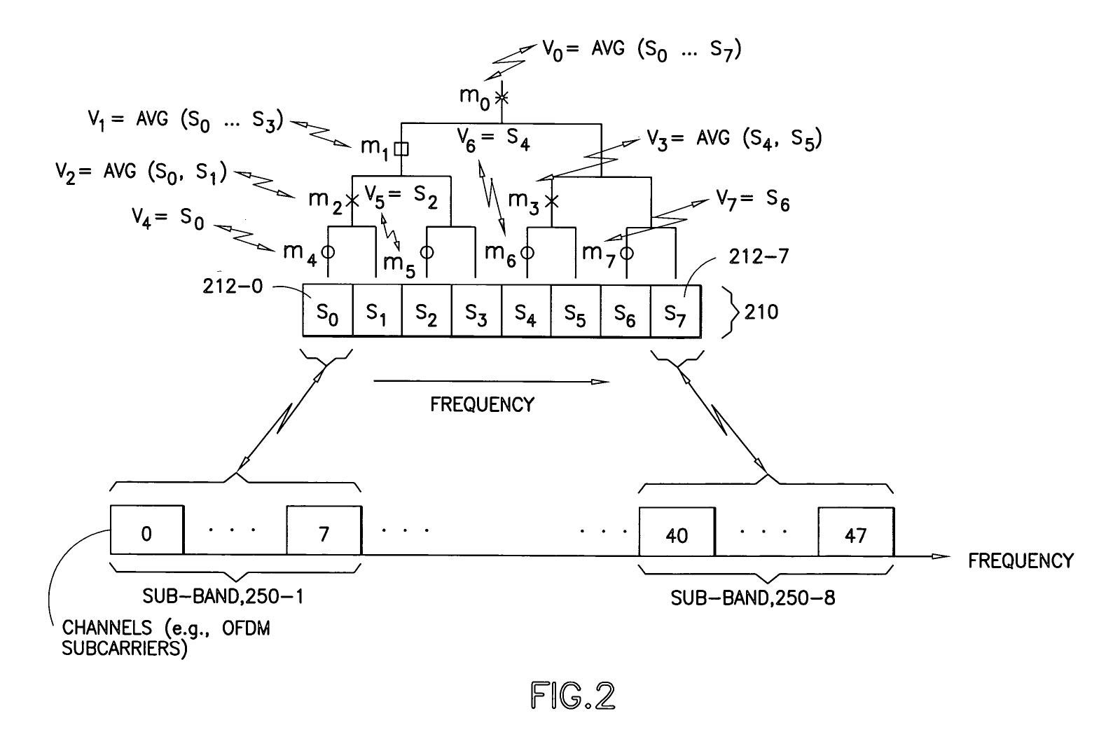

The UEs 10 will typically communicate with the Node B 12 using one or more resources. One such resource includes the sub-frame 51 and the sub-frame 52, which are time-based resources and part of frames 54 and 55, respectively. Messages m₀ and m₁ are discussed below. It is noted that the blocks containing m₀ and m₁ are merely for ease of explanation and not to be construed as limiting the messages in any way. In particular, the UEs 10 can communicate using resources such as channels (e.g., OFDM carriers) that are frequency-based. See, e.g., FIG. 2.

The link adaptation module 12F handles the per-user performance optimization. That is, the LA 12F will evaluate the link quality, e.g., based on the CQI values, for a given user (e.g., one of the UEs 10-1 through 10-N), and calculate which transmission parameters are to be used to utilize the radio link (e.g., a portion of the wireless link shown in FIG. 1) in a suitable (e.g., the ‘best’) way, given some constraints. For instance, the LA 12F could determine the modulation and coding to be used for a given user, provided that certain physical resource blocks are allocated to this user. The packet scheduling module 12E handles the multi-user aspect. That is, the PA 12E finds a suitable (e.g., the ‘best’) way to divide the physical resource blocks between a set of users to be scheduled. The final scheduling decision (PRB allocation, modulation, and coding) is decided through the negotiation between the two modules 12E and 12F, with the PS 12F generally being in charge (as the PS 12F knows the priority between the users). In an exemplary embodiment, therefore, the PS 12F handles the allocation of physical resources, while the LA 12F handles the utilization of the physical resources.

The modules 10E, 12E, and 12F may be embodied in software (e.g., firmware) and/or hardware, as is appropriate. In general, the exemplary embodiments of this invention may be implemented by computer software executable by the DP 10A, 12A of the UEs 10, Node B 12, respectively, or by hardware, or by a combination of software and/or firmware and hardware.

In general, the various embodiments of the UEs 10 can include, but are not limited to, cellular telephones, personal digital assistants (PDAs) having wireless communication capabilities, portable computers having wireless communication capabilities, image capture devices such as digital cameras having wireless communication capabilities, gaming devices having wireless communication capabilities, music storage and playback appliances having wireless communication capabilities, Internet appliances permitting wireless Internet access and browsing, as well as portable units or terminals that incorporate combinations of such functions.

The MEMs 10B and 12B (and 14B) may be of any type suitable to the local technical environment and may be implemented using any suitable data storage technology, such as semiconductor based memory devices, magnetic memory devices and systems, optical memory devices and systems, fixed memory and removable memory. The DPs 10A and 12A (and 14A) may be of any type suitable to the local technical environment, and may include one or more of general purpose computers, special purpose computers, microprocessors, large scale integrated circuits, digital signal processors (DSPs) and processors based on a multi-core processor architecture, as non-limiting examples. It is noted that embodiments herein may be implemented as a computer program product that tangibly embodies a program of machine-readable instructions executable by at least one data processor to perform operations described herein. Such a computer program product may include, e.g., compact disk read only memory (CDROM), digital versatile disk (DVD) memory, a memory stick, magnetic memory, or the like.

In an attempt to alleviate the CQI signaling problem discussed above compression of the combined CQI message has been proposed. In addition, it has been proposed in 3GPP TSG RAN#43 (Seoul, Korea; Nov. 7-11, 2005; R1-051334) to use threshold-based CQI reporting associated with a bitmap indicating which resource blocks are suited for transmission. Further, consideration has been made in 3GPP TSG RAN WSG1#44 (Denver, USA; Feb. 13-17, 2006; R1-060641) of making the CQI reporting event based such that CQI report updates are only sent whenever they have changed by some predetermined amount. Another approach proposed in 3GPP TSG RAN1#44 (Helsinki, Finland; Jan. 23-25, 2006; R1-060018) would include using time staggering such that a CQI report is sent in smaller pieces (such that it will require several sub-frames to transmit the full CQI report).

None of these proposals, however, provides a truly optimum solution to the CQI signaling problem.

One suitable and non-limiting technique for the UEs 10 to make CQI measurements in preparation for determining the CQI measurement reports, in accordance with the exemplary embodiments of this invention, is specified in 3GPP TS (technical standard) 25.214 rev 6.7.1, (especially Section 6A.2). This section states the following: “Based on an unrestricted observation interval, the UE shall report the highest tabulated CQI value for which a single HS-DSCH sub-frame formatted with the transport block size, number of HS-PDSCH codes and modulation corresponding to the reported or lower CQI value could be received in a 3-slot reference period ending 1 slot before the start of the first slot in which the reported CQI value is transmitted and for which the transport block error probability would not exceed 0.1.” HS-DSCH stands for high speed—downlink shared channel. Current versions of LTE operate with the term physical resource block (PRB), which covers, e.g., 1 ms (millisecond) in the time domain, and 12 sub-carriers in the frequency domain (e.g., each carrier having a bandwidth of 180 kHz). Within such a 1 ms period, it is possible to schedule several PRBs (distributed over the frequency band in blocks of 180 kHz). The user payload data that is transmitted on the physical resources is typically called a transport block. In FIG. 1, a PRB covers 0.5 ms in the time domain, and the exemplary embodiments of the disclosed invention are not limited to a specific time period or number of sub-carriers.

The exemplary embodiments of this invention provide an alternative reporting approach when signaling, e.g., time staggered CQI reports. The reporting mechanism is based on a tree structure (see FIG. 2) or other hierarchy, such that the packet scheduler/link adaptation functions 12E, 12F have, e.g., an average CQI for the full bandwidth. Subsequently transmitted CQI reports increase the granularity in terms of frequency, such that after the full reporting period, the Node B 12 has a complete report. The exemplary embodiments of this invention thus provide for more accurate channel quality measurements to be made at the UEs 10, and also provide for the Node B 12 to perform user scheduling prior to the time that the complete CQI report has been received.

To illustrate the foregoing principles in accordance with the exemplary embodiments of this invention, consider in FIG. 2 where the complete CQI report 210 is divided into, as a non-limiting example, eight sub-reports 210-0 through 210-7, respectively, each sub-report including a corresponding value from the values s₀-s₇. Each sub-report 210 may, for example, represent a group of subcarriers, a so-called resource block, in the frequency domain. This is true, in an exemplary embodiment, because the only reference symbols that exist are for determining the channel quality on part of the sub-carriers within a resource block. A specific, but non-limiting example is shown in FIG. 2, where 48 OFDM subcarriers 0-47, are shown. The sub-report 210-0 corresponds to a value, s₀, for the subcarriers zero through seven, while the sub-report 210-7 corresponds to a value, s₇, for the subcarriers 40-47. The technique may be expanded to cover any number of sub-reports per CQI report. The sub-report 212 conveys desired information and may represent, as non-limiting examples, the SINR or supported data rate for each sub-band 250-1 through 250-8 in the frequency domain. It is noted that a channel for a single user is defined by a combination of resources, such as a set of physical resource blocks, channel coding, and modulation.

However, in order to optimize the total transmission, the sub-reports 212 are not sent directly. Instead, the CQI module 12E represents the complete CQI report 210 as converted into eight CQI messages (denoted m₀-m₇ in FIG. 2), which are transmitted in an exemplary embodiment in sequence from m₀ to m₇. Again, the number of reports is chosen for the specific example considered here. The technique may be generalized to other cases as well. In the abovementioned case, it requires eight transmissions before the complete CQI report 210 is received at the Node B 12. Two such transmissions are shown in FIG. 1, where message m₀ is transmitted in a transmission interval of sub-frame 51 and message m₁ is transmitted in a transmission interval of sub-frame 52. The messages are communicated in a time-staggered manor because, for instance, in FIG. 1, message m₀ is communicated in sub-frame 50, while after some delay (e.g., of the rest of a time frame 54), a message m₁ is communicated. It is noted that message m₀ is received in a reception interval of sub-frame 51 and message m₁ is received in a reception interval of sub-frame 52. It is further noted that CQI information is typically assigned certain time periods for transmission/reception, generally called CQI reporting intervals. Thus, sub-frames 51 and 52 represent CQI reporting intervals in this example.

The message tree notation and hierarchical structure shown in FIG. 2 denotes over which sub-bands 250 each of the eight messages is created/measured. The first message sent by the UE 10-1 (m₀ represented by the asterisk) is in the top of the tree (which may be designated as the root node or the trunk and is at the highest level) and is thus created by creating a value v₀ that averages all the sₓ values from s₀ to s₇. The next message is m₁ and is represented by the first branch (and node) in the tree. As m₁ is located one level lower than m₀, the m₁ message is obtained by determining a value v₁ by averaging the sₓ values s₀ to s₃. Significantly, by having knowledge of the values (v₀ and v₁) in m₁ and m₀, the Node B 12 can automatically determine the average CQI value of s₄ to s₇ without explicit signaling (discussed below is the case where a CQI message m₀ . . . m₇ is not received correctly). The procedure continues in the same manner to send. m₂, then to send messages in progressively lower ‘levels’ of the tree shown in FIG. 2. In general, messages (and their corresponding nodes) in a particular level represent the same number of the most detailed sub-reports 212 (having values s₀ through s₇ in FIG. 2), or substantially the same number (e.g., differing by one) where the total number of the most detailed sub-reports 212 is not evenly divisible by the number of messages in a particular level. Each new message increases the granularity and accuracy of the report (i.e., converging towards the most accurate CQI estimates of the original s₀ to s₇ values).

It is noted that FIG. 2 is illustrated using an even number of sub-reports 212. The tree structure shown is easily adapted to a number of leaves that is described by 2^{N}. However, in LTE or other systems, it might not be possible to write messages as 2^{N}. Regardless, to some extent, some simplifications can be made, which will approximately maintain the 2^{N} property, as shown by the following non-limiting example:

1. If there are 50 reports, average over the full bandwidth;

2. When calculating the second node (i.e., the value of the message) at the second level), use 25 PRBs for each node;

3. Third nodes (i.e., the values of the messages) at the third level: each parent node is divided into 12 and 13 PRBs each;

4. Fourth nodes (i.e., the values of the messages) at fourth level: each parent node is divided into all even or an even and an odd numbers of PRBs: the parent node with 12 PRBs is divided into 6+6, and the parent node with 13 PRBs is divided into 6+7 PRBs;

5. Fifth nodes (at fifth level): 3+3, 3+3, 3+3, and 3+4 PRBs; and

6. Sixth nodes (at sixth, lowest level): As it is not possible to divide the blocks of ‘3’ PRBs in a simple way, at this level of the tree structure it is necessary to consider each PRB by itself. Still, it should be remembered that even in this case, one can derive the value of a PRB at this lower layer of the tree by knowing the value at the fifth node and two of the reports at the sixth level.

Note that the order in which the various messages may be transmitted need not follow the sequential numbering of messages shown in FIG. 2, though preferably all messages in one level of the tree are sent prior to sending any messages from lower levels of that same tree. For example, m₀ would be sent first, followed by m₁. Messages m₂ and m₃ are sent after m₁, in any order that might be specific to a particular implementation. Following transmittal of m₂ and m₃, messages m₄, m₅, m₆ and m₇ are sent, again in any particular order that might be advantageous for a particular implementation. The order is preferably pre-determined so that the receiver knows which sub-reports 212 are reflected in any particular received message. While FIG. 2 shows only four different levels of messages (apart from the sub-reports 212-0 through 212-7, containing values s₀ through s₇, respectively), any number of message levels may be implemented where there are more or less than the eight illustrated sub-reports 212.

Exemplary rationale for the measurement reporting structure shown in FIG. 2 is as follows.

A. First, the average CQI report for the full reporting bandwidth (as indicated by s₀ to s₇) is calculated and sent as the measurement report m₀. As the UE 10-1 accumulates the CQI estimates, there is an averaging effect that reduces the measurement error. This is very beneficial, as it is important to have an accurate estimate of the average CQI over the full bandwidth. The accuracy of the measurement will typically be limited only by the available signaling resolution in the uplink.

B. When calculating the average CQI value v₁ for the first half of the bandwidth (and transmitting same in message m₁ to the Node B 12), a Node B algorithm is enabled to readily calculate the corresponding CQI value for the last half of the measurement bandwidth (e.g., indicated by sub-reports 210-4 through 210-7 and s₄ through s₇). This enables UE operations that use the CQI measurements to proceed without having to first receive the entire CQI measurement report at the Node B 12.

C. The third and fourth reports are obtained by halving the measurement bandwidths of each interval in FIG. 2. Correspondingly, the Node B 12 is enabled to obtain the ‘missing’ reports from the already received reports.

It can be seen that the same number of CQI segments are needed to deliver a full measurement report 210, however, using the exemplary embodiments of this invention the Node B 12 initially obtains an accurate report on the overall link performance (e.g., v₀, which is the average of s₀ to s₇) reported by the UE 10-1, and using subsequent reports, the resolution and accuracy is gradually increased. Further, by enabling the higher detail reports (e.g., m₄ through m₇) to be measured over a longer time interval, measurement error for those more detailed reports is reduced due to the greater number of reference symbols available.

It can be the case that a message loss rate for the UEs 10 control signaling (CQI) may be in the range of about one percent to two percent. Hence, it may be expected that some of the messages m₀ through m₇ will not be received at the Node B 12. If, assuming the case of the abovementioned example, the Node B 12 were to miss message m₀, the Node B 12 has in one example one option when receiving m₁, i.e., to assume that m₀=m₁. Fortunately, this is not an unrealistic assumption in the wideband channel of particular interest to the exemplary embodiments of this invention. In other words, setting m₀=m₁ may not be that detrimental in practical applications. If some of the later CQI reporting messages m₁ through m₇ are not correctly received, the uncertainty is then only limited to a smaller portion of the complete frequency band (e.g., spanning sub-bands 250-1 through 250-8). In any case, the Node B 12 has knowledge regarding the certainty of the CQI measurement reports received from the UEs 10 (e.g., whether one or more CQI reporting messages were incorrectly received) and may take this knowledge into account when making its scheduling decision(s).

If one maintains the same resolution and bandwidth for all the messages m₀-m₁, it has been found from simulations, including measuring errors and quantization errors, that an average 0.1 dB error results as compared to sending directly the sₓ values. By defining an unequal resolution of, e.g., the m₀ message and the m₄ message, it becomes possible to cancel out the error and provide a theoretically equal resulting error on all the extracted sₓ values. Thus, it is within the scope of the exemplary embodiments of this invention to optionally allocate different word sizes for the different messages m₀ through m₇ (and the corresponding values v₀ through v₇) according to their relative importance. Typically, therefore, more bits would be allocated to m₀ than m₇, if different allocations are used. The exemplary embodiments of this invention enable the shifting of the signaling resolution between the individual messages in order to cancel out the error and also more effectively equalize the error distribution on the extracted sₓ values.

As should be appreciated, a number of advantages can be realized by the use of the exemplary embodiments of this invention. For example, the use of the exemplary embodiments of this invention provides a gradually increasing measurement resolution, while at the same time providing an accurate measurement report of the general link quality. Further, and while time staggering is an effective technique to reduce the CQI signaling, it also introduces an additional link adaptation and packet scheduling delay. However, by the use of the exemplary embodiments of this invention the PS 12E and LA 12F modules are enabled to schedule the UE 10-1 (and UEs 10-1 through 110-N) with minimum delay (e.g., use distributed scheduling/adaptation which corresponds well to the first message m₀) and gradually increase the aggressiveness of the scheduling as additional CQI measurement reporting messages are received.

While there may some additional decoding complexity in the Node B 12 (e.g., in the above example, eight equations with eight unknowns need to be solved), in practice the decoding procedure may be hard coded and thus made very efficient.

Further in accordance with the exemplary embodiments of this invention, a time evolution may be into account such that the relative measurement reports sent later than the time instant for ‘m0’ are used as a reference, while still considering that the original value for ‘m0’ has some particular value. This approach may increase the accuracy (by reducing the relative ‘age’ of the measurement reports), and/or may result in a more accurate measure of CQI due to the higher number of reference symbols available due to the larger time interval over which the more detailed reports are measured.

In general terms, it is beneficial to have the best measurements possible. Measurement accuracy can be improved by taking measurements over time. In an exemplary embodiment, all the measurements start with reference to the initial measurement of s₀ to s₇. The value for message m₀ is calculated as the average of the s₀ to s₇. Now, while transmitting m₀ and times thereafter, it is possible to continue to measure a new set of s₀ to s₇. Provided that there is a quite stable radio channel over the observation interval, the new set of s₀ to s₇ will not have changed significantly, and it should be suitable to average over time to improve the estimate. As m₄ to m₇ are, in this example, calculated using time averages, still including the input from the initial measurement, there is a beneficial averaging effect for the subsequent reports. On the other hand, if channel conditions are such that averaging leads to highly variable averages (for instance, ten percent deviation), then averaging might not be possible.

Furthermore, it is possible to also transmit more than one of the ‘mₓ’ messages per sub-frame 50, 51.

Further, while described in the context of CQI measurement reporting for a plurality of sub-bands, it is within the scope of the exemplary embodiments of this invention to use the above described UEs 10 and Node B 12 procedures for other types of measurement reporting.

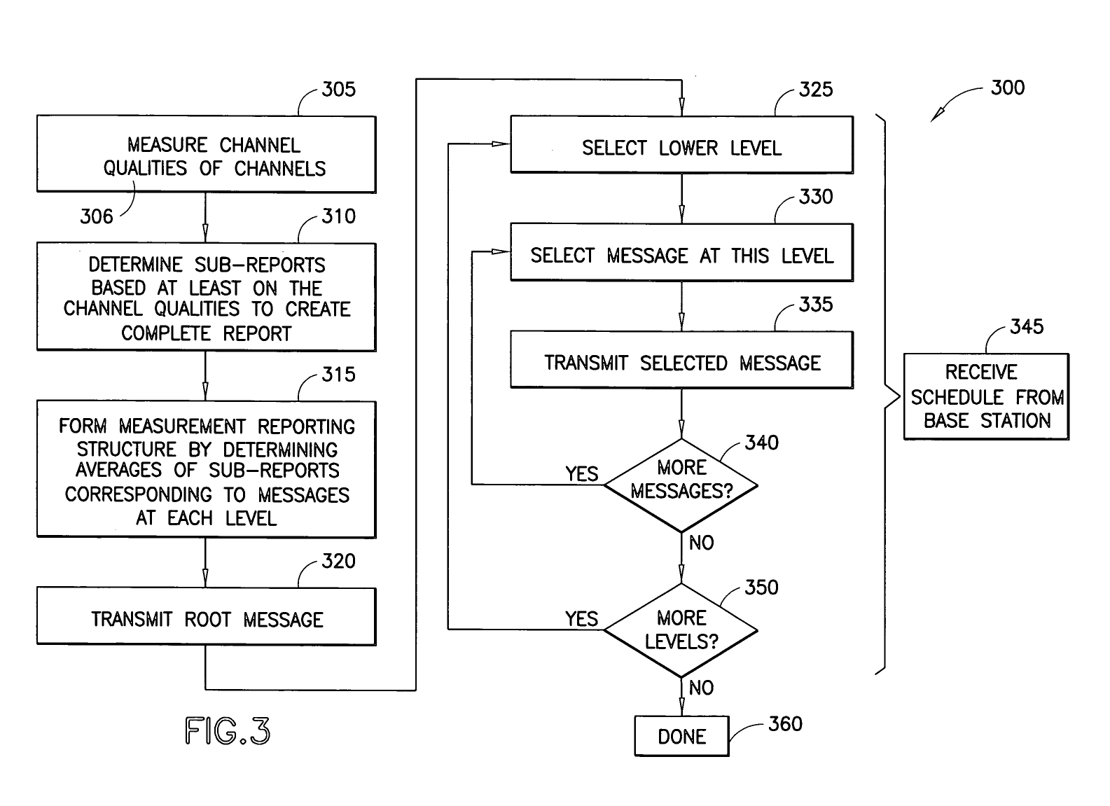

Referring to FIG. 3 (along with previous figures), a flowchart is shown of an exemplary method 300 performed by a UE for providing tree-based signaling of measurement reports. Method 300 is performed, e.g., by CQI module 10E and DP 10A of a UE 10. Method 300 assumes a varying channel such that averaging over a long time period, such as averaging several CQI values taken at discrete times in a time span containing multiple reporting intervals, is not performed. It should be noted, however, that during a typical CQI measurement, a measurement is performed over a short time period, e.g., several milliseconds. In block 305, the channel qualities 306 of channels are measured. In block 310, the sub-reports 212 are determined based at least on the channel qualities 306, in order to create a complete report 210. It is noted that it might be possible to combine blocks 305 and 310, for instance if the sub-reports 212 are the channel qualities 306. This is what is assumed in FIG. 2, where the values s₀-s₇ are values of CQI measurements. However, the sub-reports 212 might be chosen from a pre-selected group of symbols, such that a given CQI value is translated to a given symbol.

In block 315, the measurement reporting structure (e.g., including m₀-m₇) shown in FIG. 2 is created by determining averages of sub-reports 212 at each of the levels. In block 320, the root message, m₀, is transmitted. In block 325, a lower level is selected and in block 330, a message at this lower level is selected. In block 335, the selected message is transmitted. In block 340, it is determined if there are more messages in this level. If so (block 340=YES), the method 300 returns to block 330. If not (block 340=NO), in block 350, it is determined if there are more levels. If so (block 350=YES), another level is selected in block 325. If no (block 350=NO), the method ends in block 360.

It is noted that in block 345, the UEs 10 can receive a schedule from the base station 12 at any time, e.g., after transmission of the root message. In fact, the UEs 10 may receive multiple schedules from the base station 12.

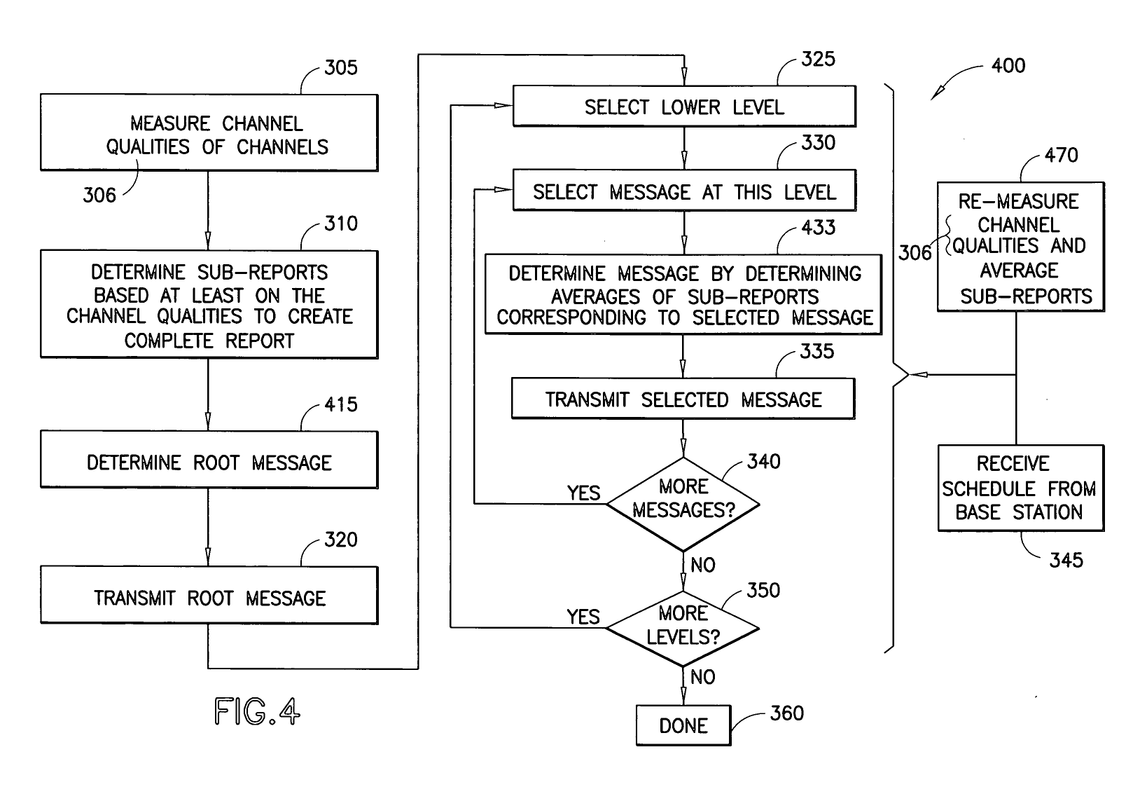

Turning to FIG. 4 (along with previous figures), a flowchart is shown of another exemplary method 400 performed by a UE 10 for providing tree-based signaling of measurement reports. Method 300 is performed, e.g., by CQI module 10E and DP 10A of one of the UEs 10. Method 300 assumes a relatively stable channel such that averaging over time is performed. Most of the blocks in FIG. 4 have been discussed in reference to FIG. 3. Therefore, only the different blocks will be discussed. In FIG. 4, block 415 replaces block 315 of FIG. 3. Although block 315 could be performed in method 400, typically only the root message, m₀, need be determined prior to block 320. Consequently, in block 415, the root message, m₀, is determined.

In block 433, a selected one of the remaining messages m₁-m₇ is determined by averaging associates sub-reports 212. In block 470, the channel qualities 306 are re-measured and sub-reports 212 are determined using the re-measured channel qualities 306, and the current sub-reports are averaged with previously determined sub-reports. Block 470 can occur a number of times while blocks 320-350 are performed.

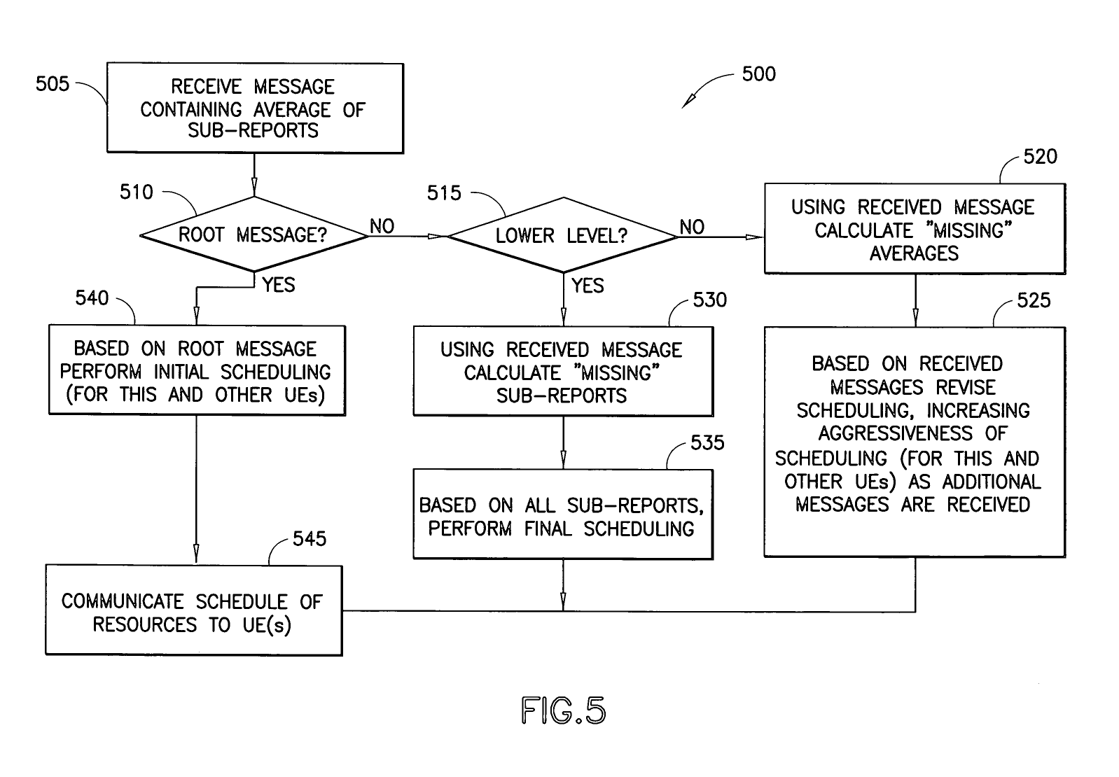

FIG. 5 is a flowchart of an exemplary method 500 performed by a base station for performing scheduling based on tree-based signaling of measurement reports. The scheduling performed in method 500 is performed by one or both the PS 12E and the LA 12F. The other portions of method 500 are performed, e.g., by the DP 12A (along with the PROG 12C for those embodiments using software). It is noted that although primary emphasis in the discussion of FIG. 5 is placed on receiving messages from a single UE, a base station will receive messages from multiple UEs. Similarly, although primary emphasis in the discussion of FIG. 5 is placed on scheduling a single user (e.g., UE 10-1), a base station will schedule multiple users (e.g., a portion or all of the UEs 10).

Method 500 begins in block 505, when a message (e.g., m₀-m₇) is received containing an average of sub-reports. In block 510, it is determined if the message is a root message (e.g., by determining if this is the first message). If the message is a root message (block 510=YES), in block 540, based on the root message, initial scheduling is performed and is communicated (block 545) to the UE 10. If the message is not the root message (block 510=NO), it is determined if the message corresponds to the lowest level of the measurement reporting structure. If not (block 515=NO), in block 520, the “missing” averages are calculated using the received message. In block 525, based on the received messages (and the “missing” averages), the scheduling is revised. Typically, the aggressiveness of the scheduling is increased as additional messages are received. For example, with first message (i.e., the root message), the base station 12 (e.g., the PS 12E and LA 12F) might assign a moderate modulation and coding scheme over all the allocated bandwidth to a single UE 10 (e.g., UE 10-1). When all messages are received, the base station 12 may assign only half the bandwidth to this user (e.g., UE 10-1) with double the modulation and coding but then assign the remaining bandwidth to another user (e.g., UE 10-2) to gain overall increased data rate. Hence, aggressiveness may correspond to both the individual user but also to all the scheduled users (e.g., one user need not see a data rate benefit). Overall, the assigned throughput/data rates have been increases at cell level (e.g., each base station 12 can support one or more cells) for that scheduling instance. The method 500 continues in block 545.

If the message is at the lowest level (block 515=YES), in block 530, using the received message, the “missing” sub-reports 212 are calculated. In block 535, based on all of the sub-reports 212, final scheduling is performed. The method 500 again communicates a schedule of the resources to the UE 10.

It is noted that this method 500 assumes that scheduling would occur with each message. However, this might not be the case and is merely exemplary.

In general, the various embodiments may be implemented in hardware such as special purpose circuits or logic, software, or any combination thereof. For example, some aspects may be implemented in hardware, while other aspects may be implemented in software (e.g., firmware) which may be executed by hardware such as a controller, microprocessor or other computing device, although the invention is not limited thereto. While various aspects of the invention may be illustrated and described as block diagrams, flow charts, or using some other pictorial representation, it is well understood that these blocks, apparatus, systems, techniques or methods described herein may be implemented in, as non-limiting examples, hardware (e.g., special purpose circuits or logic, general purpose hardware or controllers or other computing devices), or software, or some combination thereof.

Embodiments of the inventions may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

Programs, such as those provided by Synopsys, Inc. of Mountain View, Calif. and Cadence Design, of San Jose, Calif. automatically route conductors and locate components on a semiconductor chip using well established rules of design as well as libraries of pre stored design modules. Once the design for a semiconductor circuit has been completed, the resultant design, in a standardized electronic format (e.g., Opus, GDSII, or the like) may be transmitted to a semiconductor fabrication facility or “lab” for fabrication.

Various modifications and adaptations may become apparent to those skilled in the relevant arts in view of the foregoing description, when read in conjunction with the accompanying drawings. For instance, in reference to FIG. 2, averaging (i.e., mean) was used to determine values representative of corresponding subsets or sets of the channels. However, other mathematical functions may be used, such as using a median value, maximum value, or minimum value. Consequently, any and all modifications of the teachings of this invention will still fall within the scope of the non-limiting embodiments of this invention.

Furthermore, some of the features of the various non-limiting embodiments of this invention may be used to advantage without the corresponding use of other features. As such, the foregoing description should be considered as merely illustrative of the principles, teachings and exemplary embodiments of this invention, and not in limitation thereof.

What is claimed is:

1. A method comprising:
determining a value representative of an overall quality of a set of channels;
transmitting during a reporting interval an indication of the determined value;
determining at least one additional value representative of a quality of a subset of the set of channels; and
transmitting in at least one subsequent reporting interval an indication of the at least one additional value.

2. The method of claim 1, wherein each of the values is determined by averaging values for qualities of each of the channels in an associated set or subset of channels.

3. The method of claim 1, wherein each of the set of channels is defined by at least a physical resource block corresponding to a plurality of subcarriers.

4. The method of claim 1, wherein each of the values is representative of at least one of signal to interference noise ratio (SINR), channel quality indication, or data rate.

5. The method of claim 1, further comprising receiving a schedule including an indication of at least one channel to use for communication, the received schedule based at least in part on at least one of the values.

6. The method of claim 1, wherein the values are determined using a tree structure having a plurality of levels from a highest level to a lowest level and a number of nodes at each level, each node corresponding to a value, wherein lower levels have higher numbers of nodes as compared to a number of nodes at higher levels, and wherein a single node at the highest level corresponds to the value representative of the overall quality.

7. The method of claim 6, wherein nodes in higher levels correspond to values representative of a larger number of channels in the set and nodes in lower levels correspond to values representative of a smaller number of channels in the set.

8. The method of claim 7, wherein all of the nodes at any one level beneath the highest level correspond to all of the channels in the set, and wherein determining at least one additional value further comprises determining values for only a portion of the nodes at any one level beneath the highest level.

9. The method of claim 7, further comprising encoding the values to create corresponding ones of the indications, the encoding performed using a larger number of bits to encode the value corresponding to the highest layer as compared to a number of bits used to encode a single value corresponding to the lowest level.

10. The method of claim 1, wherein:
determining at least one additional value further comprises determining a plurality of additional values representative of qualities of different subsets of the set of channels; and
transmitting further comprises transmitting in a plurality of subsequent reporting intervals indications of the plurality of additional values.

11. The method of claim 10, wherein determining a plurality of additional values performs a plurality of determinations over a time interval for particular ones of the additional values and an average of values determined in the determinations is used as an associated one of the particular additional values.

12. The method of claim 10, wherein the different subsets of the set of channels are selected to increase accuracy of the qualities relative to qualities of single ones of the channels in associated subsets, and wherein the transmitting is performed to transmit less accurate values in earlier reporting intervals and more accurate values in later reporting intervals.

13. An apparatus comprising:
a quality module configured to determine a value representative of an overall quality of a set of channels and configured to determine at least one additional value representative of a quality of a subset of the set of channels; and
a transceiver configured to transmit during a reporting interval an indication of the determined value and configured to transmit in at least one subsequent reporting interval an indication of the at least one additional value.

14. The apparatus of claim 13, wherein at least the quality module is implemented at least in part on an integrated circuit.

15. The apparatus of claim 13, wherein:
the quality module is further configured to determining a plurality of additional values representative of qualities of different subsets of the set of channels, wherein the different subsets of the set of channels are selected to increase accuracy of the qualities relative to qualities of single ones of the channels in associated subsets; and
the transceiver is further configured to transmit in a plurality of subsequent reporting intervals indications of the plurality of additional values, and wherein the transmission of the plurality of additional values is performed to transmit less accurate values in earlier reporting intervals and more accurate values in later reporting intervals.

16. A computer program product tangibly embodying a program of machine-readable instructions executable by at least one data processor to perform operations comprising:
determining a value representative of an overall quality of a set of channels;
transmitting during a reporting interval an indication of the determined value;
determining at least one additional value representative of a quality of a subset of the set of channels; and
transmitting in at least one subsequent reporting interval an indication of the at least one additional value.

17. The computer program product of claim 16, wherein:
determining at least one additional value further comprises determining a plurality of additional values representative of qualities of different subsets of the set of channels, wherein the different subsets of the set of channels are selected to increase accuracy of the qualities relative to qualities of single ones of the channels in associated subsets; and
transmitting further comprises transmitting in a plurality of subsequent reporting intervals indications of the plurality of additional values, and wherein the transmitting of the plurality of additional values is performed to transmit less accurate values in earlier reporting intervals and more accurate values in later reporting intervals.

18. A method comprising:
receiving during a reporting interval an indication of a value representative of an overall quality of a set of channels;
receiving during at least one subsequent reporting interval an indication of at least one additional value representative of a quality of a subset of the set of channels;
using the values, scheduling resources associated with the channels in the set; and
transmitting an indication of the scheduled resources.

19. The method of claim 18, wherein receiving an indication of a value and receiving an indication of at least one additional value are performed for a plurality of users, and wherein scheduling resources further comprises scheduling resources associated with the channels for the plurality of users.

20. The method of claim 18, wherein receiving an indication of at least one additional value further comprises receiving during a plurality of subsequent reporting intervals a plurality of indications of a plurality of additional values representative of qualities of different subsets of the set of channels, and wherein scheduling resources further comprises scheduling resources using an initial set of the indications at an initial time and revising the scheduled resources using another set of the indications at a later time.

21. The method of claim of claim 18, wherein scheduling resources comprises allocating physical resources associated with the channels in the set and allocating utilization of the physical resources associated with channels in the set.

22. The method of claim 21, wherein the physical resources comprise at least a physical resource block corresponding to a plurality of subcarriers.

23. The method of claim 18, wherein each of the values was determined by averaging values for qualities of each of the channels in an associated set or subset of channels.

24. The method of claim 18, wherein each of the values is representative of at least one of signal to interference noise ratio (SINR), channel quality indication, or data rate.

25. The method of claim 18, wherein the values were determined using a tree structure having a plurality of levels from a highest level to a lowest level and a number of nodes at each level, each node corresponding to a value, wherein lower levels have higher numbers of nodes as compared to a number of nodes at higher levels, and wherein a single node at the highest level corresponds to the value representative of the overall quality.

26. The method of claim 25, wherein nodes in higher levels correspond to values representative of a larger number of channels in the set and nodes in lower levels correspond to values representative of a smaller number of channels in the set.

27. The method of claim 26, wherein all of the nodes at any one level beneath the highest level correspond to all of the channels in the set, the at least one additional values were determined for only a portion of the nodes at any one level beneath the highest level, and wherein the method further comprises calculating a value that was not determined for at least one node in a particular level based on additional values that were determined for nodes in that particular level and higher levels.

28. The method of claim 26, wherein the values are encoded using an encoding scheme to create associated ones of the indications, the encoding performed using a larger number of bits to encode the value corresponding to the highest layer as compared to a number of bits used to encode a single value corresponding to the lowest level, and wherein the method further includes decoding the indications according to the encoding scheme to create corresponding ones of the values.

29. The method of claim 18, wherein:
receiving during at least one subsequent reporting interval an indication of at least one additional value further comprises receiving during a plurality of subsequent reporting intervals a plurality of additional values representative of qualities of different subsets of the set of channels; and
scheduling resources further comprises scheduling resources using at least some of the plurality of additional values.

30. The method of claim 29, wherein the different subsets of the set of channels are selected to increase accuracy of the qualities relative to qualities of single ones of the channels in associated subsets, and wherein reception of the values occurs so that less accurate values are received in earlier reporting intervals and more accurate values are received in later reporting intervals.

31. The method of claim 30, wherein scheduling resources further comprises increasing aggressiveness of scheduling as more accurate values are received.

32. An apparatus comprising:
a transceiver configured to receive during a reporting interval an indication of a value representative of an overall quality of a set of channels and configured to receive during at least one subsequent reporting interval an indication of at least one additional value representative of a quality of a subset of the set of channels; and
at least one scheduling module configured, using the values, to schedule resources associated with the channels in the set,
wherein the transceiver is further configured to transmit an indication of the scheduled resources.

33. The apparatus of claim 32, wherein at least the at least one scheduling module is implemented at least in part on an integrated circuit.

34. The apparatus of claim 32, wherein the at least one scheduling module further comprises a packet scheduling module and a link adaptation module.

35. The apparatus of claim 32, wherein:
the transceiver is further configured to receive during a plurality of subsequent reporting intervals a plurality of additional values representative of qualities of different subsets of the set of channels, wherein the different subsets of the set of channels are selected to increase accuracy of the qualities relative to qualities of single ones of the channels in associated subsets, wherein reception of the plurality of additional values occurs so that less accurate values are received in earlier reporting intervals and more accurate values are received in later reporting intervals; and
the at least one scheduling module is further configured to schedule resources using at least some of the plurality of additional values.

36. A computer program product tangibly embodying a program of machine-readable instructions executable by at least one data processor to perform operations comprising:
receiving during a reporting interval an indication of a value representative of an overall quality of a set of channels;
receiving during at least one subsequent reporting interval an indication of at least one additional value representative of a quality of a subset of the set of channels;
using the values, scheduling resources associated with the channels in the set; and
transmitting an indication of the scheduled resources.

37. The computer program product of claim 36, wherein:
receiving during at least one subsequent reporting interval an indication of at least one additional value further comprises receiving during a plurality of subsequent reporting intervals a plurality of additional values representative of qualities of different subsets of the set of channels, the different subsets of the set of channels are selected to increase accuracy of the qualities relative to qualities of single ones of the channels in associated subsets, wherein reception of the plurality of additional values occurs so that less accurate values are received in earlier reporting intervals and more accurate values are received in later reporting intervals; and
scheduling resources further comprises scheduling resources using at least some of the plurality of additional values.
